(19) United States
(12) Patent Application Publication
(10) Pub. No.: US 2007/0283579 A1
(43) Pub. Date: Dec. 13, 2007

(54) Fastening device for pneumatic saw

(76) Inventor: Yu-Fu Hsieh, Taipei (TW)

Correspondence Address: TROXELL LAW OFFICE PLLC;Suite 1404, 5205 Leesburg Pike, Falls Church, VA, 22041, US

(21) Appl. No.: 11/450,466

(22) Filed: Jun. 12, 2006

(51) Int. Cl. B23D 49/00

(52) U.S. Cl. 30/392; 30/329

(57) ABSTRACT

A fastening device for pneumatic saw comrpising a body portion and a guide member mounted on the front end of the body poetion; the center thereof is mounted with a movable guide assembly connected together with a power transmission shaft; one side of the movable guide assembly is furnished with two screw holes for receiving two screw bolts respectively; the center cylindrical hole of the movable guide assembly is loaded with a chuck cylinder, which is connected with the movable guide assembly by means of screw threads therein; the chuck cylinder is furnished with a long slot; one side of the long slot has a cylindrival hole for receiving a saw blade; the cylindrical hole of the long slot is opposite to a screw hole on one side of the movable guide assembly; after a screw bolt is screwed into the screw hole, it will press the saw blade firmly in place; one side of the movable guide assembly has another screw hole for receiving another screw bolt so as to have the chuck cylinder fastened firmly in the cylindrical hole of the movable guide assembly, and to provide the saw blade with additional chuck force.

### BACKGROUND OF THE INVENTION

1. Field of the Invention

This invention relates to a pneumatic saw, and particularly to a fastening device for the saw blade of a pneumtic saw.

2. Description of the Prior Art

A conventional pneumatic saw usually comprises a body protion and a guide member on the front end of the body portion; the center of the guide member has a rectangular guide slot for receiving a rectangular guide bar as a movable guide assembly; an inner transmission shaft is used for pulling the movable guide assembly to move; simultaneously, the rectangular guide bar will move along the rectangular guide slot; the center of the movable guide assembly is furnished with a lateral slot having two screw holes on one side thereof for receiving two screw bolts respectively; a saw blade is plugged in the lateral slot, and the screw bolts are screwed in to press the saw blade in place firmly; the rectangular guide bar usually moves along the rectangular guide slot; the movable guide assembly is usually processed with heat treatment so as to have a suitable friction-proof during sliding and moving; the saw blade plugged in the slot of the movable guide assembly is merely fastened in place with screw bolts.

In the conventional pneumatic saw, the saw blade is a thin blade, which would have a reactive force during cutting; such reactive force would cause the saw blade not to move smoothly; in that case, the saw blade is subject to loosening and separating from its fastening position.

### SUMMARY OF THE INVENTION

The prime object of the present invention is to privide a fastening device for a pneumatic saw, in which the front end has a guide member with a rectangular guide slot; the rectangular guide a lot is mounted with a movable guide assembly, of which one side is furnished with two screw holes for receiving two different screw bolts in length respectively; the center of the movable guide assembly has a cylindrical hole for mounting a chuck cylinder therein; the chuck cylinder has a long slot for mounting a saw blade; one side of the chuck cylinder is furnished with a cylindrical hole beside the long slot, and in communication with a screw hole; one of the two screw bolts in the movable guide assembly goes through the cylindrical hole in the chuck cylinder to fasten the saw blade in place, while the other screw blot is fastened in the chuck cylinder to press the operning of the long slot of the chuck cylinder firmly in place.

Another object of the present invention is to provide a fastening device for a pneumatic saw, in which the inner end is furnished with inner threads for connecting the transmission shaft; the other end of the inner threads is to be screwed together with the outer threads of the chuck cylinder; an elastic washer is mounted between the cylindrical hole of the movable guide assembly and the chuck cyllinder so as to provide a buffer effect between the chuck cylinder and the movable guide assembly; then, the positioning surface of the chuck cylinder is set to face a screw hole on one side of the movable guide assembly, and to have the chuck cylinder fastened in place by means of a screw bolt.

Still another object of the present invention is to provide a fastening device for a pneumatic saw, in which a screw hole in the movable guide assembly is mounted with a screw bolt, and the screw bolt would go through a cylindrical hole in the chuck cyolinder until the end thereof pushing against one end of the saw blade in the long slot so as to fasten the saw blade firmly in place.

A further object of the present invention is to provide a fastening device for a pneumatic saw, in which a screw hole on one side of the movable guide assembly is mounted with a screw blot to push against the positioning surface of the chuck cylinder so as to have the long slot set in a clamping state tightly.

### BRIEF DESCRIPTION OF THE DRAWINGS

FIG. 1 is a perspective view of a pneumatic saw of the present invention.

FIG. 2 is a disassembled view of the present invention, showing the movable guide assembly separated from the body portion,

FIG. 3 is a disassembled view of the presen tinvention, showing the chuck structure of the chuck cylinder in the movable guide assembly.

FIG. 4 is a sectional view of the present invention, showing the chuck structure of the chuck cylinder in the movable guide assembly,

### DETAILED DESCRIPTION OF THE PREFERRED EMBODIMENT

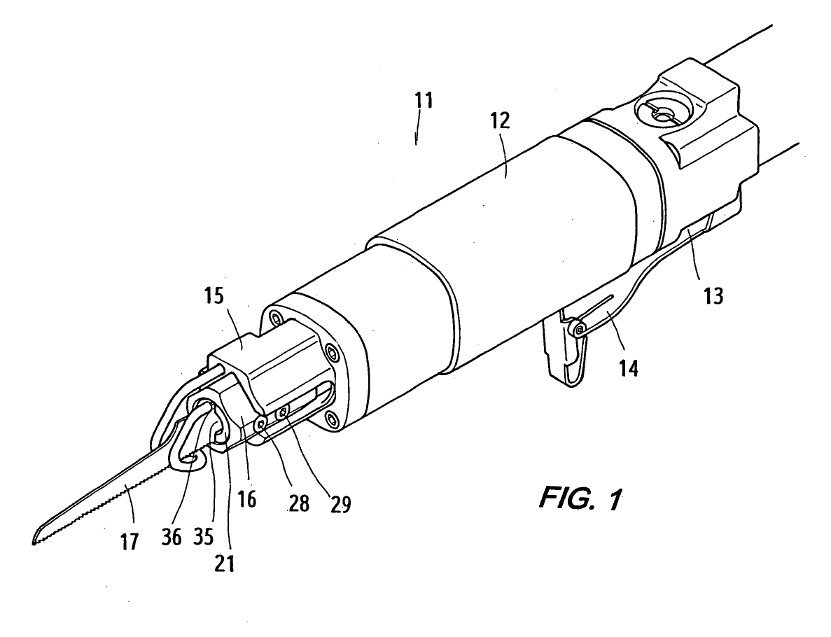

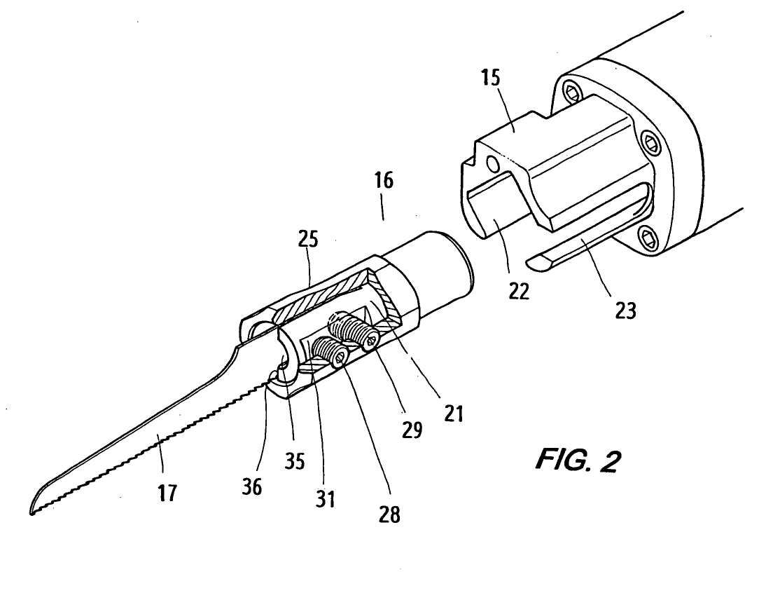

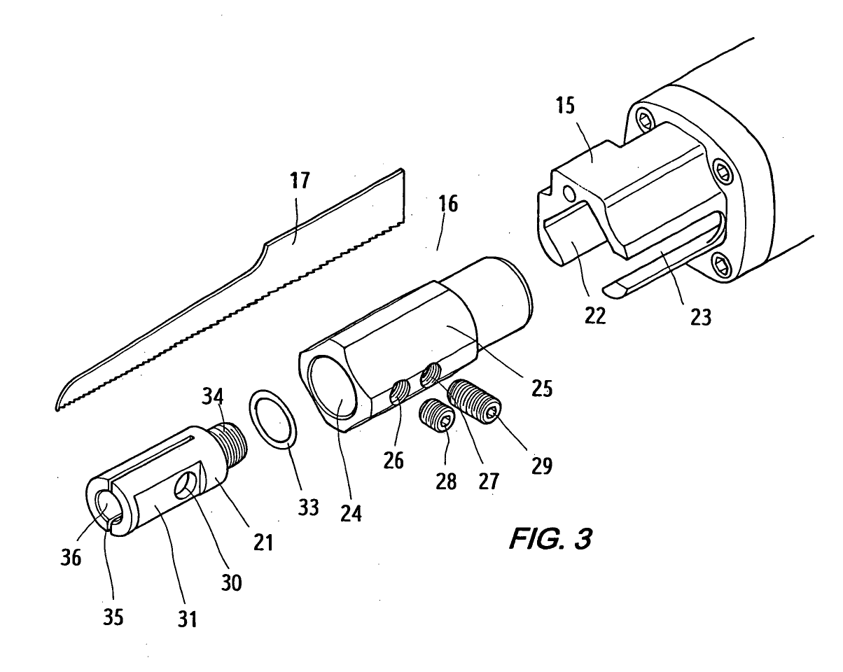

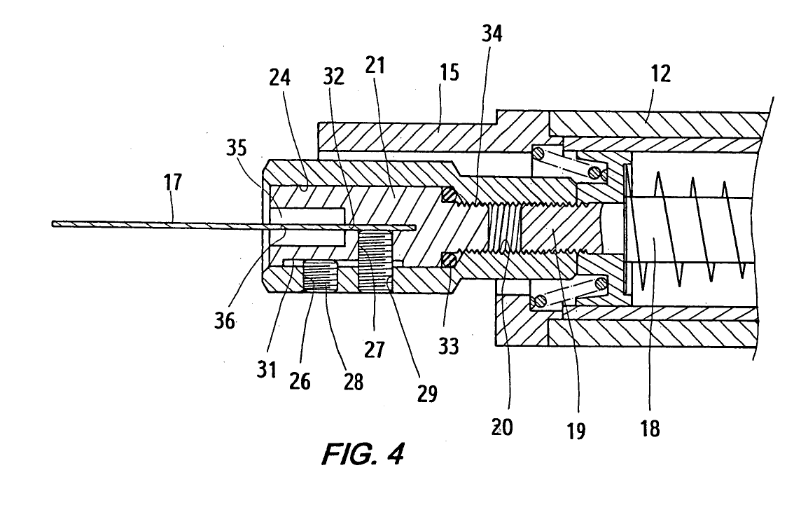

This invention relates to a fastening device for pneumatic saw; as shown in FIGS. 1 to 4, the pneumatic saw 11 mainly comprises a body portion 12 and a valve 13 mounted at the rear end of the body portion 12; the cock 14 of the valve 13 is used for controlling a pressure air to enter. The inside of the body portion 12 is mounted with a piston, which is connected with a transmission shaft 18 so as to have a power transmitted to the movable guide assembly 16; the movable guide assembly 16 is fastened with a saw blade 17; upon the piston moving back and forth, the saw blade 17 will be driven back and forth for cutting work.

To provide the movable guide assembly 16 with a directional guide, the front end of the body portion 12 is mounted with a guide member 15, of which the center is furnished with a rectangular guide slot 22 so as to have a rectangular guide bar 25 of the movable guide assembly 16 moved along the rectangular guide slot 22. Before the movable guide assembly 16 mounted in the rectangular guide slot 22 of the guide member 15, the movable guide assembly 16 and the teansmission shaft 18 are connected together first; after the fuide member 15 and the body portion 12 are fastened together, the movable guide assembly 16 is then mounted in the rectanglular guide slot 22 of the guide member 15; two screw holes 26 and 27 furnished on one side of the movable guide assembly 16 are positioned in the elongate slot 23 so as to facilitate two screw bolts 28 and 29 to fasten or remove.

One end of the movable guide assembly 16 is furnished with a cylindrical hole 24, while the other end thereof is furnished with inner threads 20 to be screwed with the transmission shaft 18. The center of the movable guide assembly 16 has a cylindrical hole 24 for mounting a chuck cylinder 21, and has inner threads 20 at one end thereof so as to have a screw rod 34 of one end of the chuck cylinder screwed therein.

The front end of the chuck cylinder 21 in the cylindrical hole 24 is furnished with a short hole 35 and a long slot 32; the width of the long slot 32 is slightly wider than that of the saw blade 17 so as to receive the saw blade 17. One side of the long slot 32 in the chuck sylinder 21 has a cylindrical hole 30 vertical to the long slot 32. After the chuck cylinder 21 is screwed in the cylindrical hole 24 of the movable guide assembly 16, the cylindrical hole 30 and the screw hole 27 on one side of the movable guide assembly 16 are in communication with each other so as to facilitate a screw bolt 29 to plug in, and to fasten the saw blade 17 in the long slot 32 firmly.

One side of the chuck cylinder 21 is furnished with a positioning surface 31, which is on the same side of the cylindrical hole 30; as soon as the chuck cylinder 21 is mounted in the cylindrical hole 24 of the movable guide assembly 16, the positioning surface 31 will face the screw hole 26 in the movable guide assembly 16; the screw hole 26 of the movable guide assembly 16 is to be mounted with a screw bolt 28, of which one end is pushed against the positioning surface 31 so as to have the slot 32 of the chuck cylinder 21 had a pressure; then, the two clamp surfaces 36 in the short hole 36 will clamp the saw blade 17 firmly in the long slot 32.

One side of the chuck cylinder 21 in the movable guide assembly 16 is furnished with a postiioning surface 31 and a cylindrical hole 30, which are opposite to the screw holes 26 and 27 in the movable guide assembly 16. The long slot 32 in the chuck cylinder 21 is used for receiving a saw blade 17; the screw hole 26 in the movable guide assembly 16 is to be screwed with a short screw bolt 28, which will be in close contact with the positioning surface 31 on the chuck cylinder 21; a long screw bolt 29 is to be screwed into the cylindrical hole 30 in the chuck cylinder 21 to push against the saw blade 17 in the long slot 32; after the long screw bolt 29 is screwed firmly against the saw blade 17, one end of the saw blade 17 will be clamped firmly in place. The short screw bolt 28 is used for exerting a pressure to the positioning surface 31 of the chuck cylinder 31. The long slot 32 at the end of the chuck cylinder 21 and the outer part of the short hole 35 form two clamp surfaces 36 to hold the saw blade 17 firmly in place.

In the present invention, the movable guide assembly 16 at the front end of the pneumatic saw 11 is added with a chuck cylinder 21 as a fastening device, which can change the force applied by means of the two screw bolts 28 and 29 in different direction; in other words, the clamp force is applied evenly in one clamp direction to provide the saw blade with more fastening force.

While the invention has been described with reference to specific embodiments it must be understood that those embodiments are susceptible to many changes, substitutions, and modifications that will be readily apparent to those having ordinary skill in the art without departing from the scope and spirit of the invention.

What is claimed is:

1. A fastening device for pneumatic saw comprising mainly a body portion, a guide member at front end of said body portion; said guide member furnished with a rectangular guide slot, in which a movable guide assembly is mounted; inner end of said mavable tguide assembly connected together with a transmission shaft, while outer end thereof being a rectangular guide bar to be mounted in said rectangular guide slot, and features thereof are described as follows:
said tansmission shaft connected with said movable guide assembly; one side of said rectangular guide bar furnished with two screw holes for receiving two screw bolts having different length; center of said movable guide assembly furnished with a cylindrical hole for receiving a chuck cylinder and a screw rod to be mounted in a screw hole in said movable guide assembly;
said chuck cylinder in a cylindrical hole of said movable guide assembly furnished with a screw rod which is connected with inner threads in said movable guide assembly; other end of said chuck cylinder having a short hole and a long slot; one side of bottom of said long slot furnished with a lateral cylindrical hole to be opposite to a screw hole on one side of said movable guide assembly, and said lateral cylindrical hole used for having a screw bolt in said movable guide assembly passed through; a positioning surface furnisehd beside said lateral cylindrival hole, and said positioning surface to be pushed against by one end of a screw bolt in a screw hole of said movable guide assembly;
one side of said movable guide assembly mounted with two screw bolts, of which one long screw bolt extended to bottom of said long slot in said chuck cylinder, while one short screw bolt pushed against said positioning surface; then, two clamp surfaces at end of said chuck cylinder able to clamp said saw blade with an even clamping force.
